(19) United States
(12) Patent Application Publication
(10) Pub. No.: US 2005/0135337 A1
(43) Pub. Date: Jun. 23, 2005

(54) Network system using common channel signalling

(76) Inventors: Akinori Nabeta, Kawasaki (JP); Kazutoshi Kobayashi, Yokohama (JP); Satoru Ogawa, Kawasaki (JP); Akishige Noda, Kawasaki (JP); Kouichi Nakajima, Yokohama (JP); Masayuki Mori, Yokohama (JP); Minoru Toyoda, Yokohama (JP)

Correspondence Address: KATTEN MUCHIN ZAVIS ROSENMAN, 575 MADISON AVENUE, NEW YORK, NY, 10022-2585, US

(21) Appl. No.: 10/858,966

(22) Filed: Jun. 2, 2004

(30) Foreign Application Priority Data
Dec. 19, 2003 (JP) 2003-422443

(51) Int. Cl. H04L 12/28; H04J 3/12

(52) U.S. Cl. 370/352; 370/400; 370/522; 379/220.01

(57) ABSTRACT

A node is a signalling end point that handles a control signal of the common channel signalling system. Four IP-STPs are signalling transfer points that transfers the control signals. A node and four IP-STPs belong to a logical network A identified by a network identifier NI=0, and four IP-STPs belong to a logical network B identified by a network identifier NI=15. In the logical network A, only one signalling point code is allocated to the four IP-STPs. The control signal is transferred using the network identifier NI and signalling point code SPC.

### BACKGROUND OF THE INVENTION

1. Field of the Invention

The present invention relates to a network system using a common channel-signalling, and more particularly to a network system for transferring control signals of common channel signalling using signalling transfer points.

2. Description of the Related Art

Recently, with promotion of IP networks, a system for connecting an existing telephone exchange network to an IP network or a system for providing an IP network service through an existing telephone exchange network has been put into practical use. As such a system, configurations disclosed in Patent documents 1 and 2 are proposed.

FIG. 1 shows the configuration of a gateway system disclosed in the Patent document 2. An exchange 101 is installed on an existing line switching network and accommodates a subscriber terminal 102. The exchange 101 is also connected to a SS7 (signalling system No. 7) network 110. The SS7 network 110 transfers control signals of the No. 7 common channel signalling in the existing line switching network.

An IP network 120 is a network for providing an IP network service. The IP network 120 comprises a media gateway (MG) 121, a signalling gateway (SG) 122 and a media gateway controller (MGC) 123. The media gateway 121 is connected to the exchange 101 and a router, which is not shown in FIG. 1, establishing the IP network 120 by a communication line or a data line, and transmits/receives signals between the existing line switching network and the IP network 120 under the control of the media gateway controller 123 (including the format conversion of signals). The signalling gateway 122 transmits/receives the No. 7 signals to/from the exchange 101 through the SS7 network, and also transmits/receives a control signal to/from the media gateway controller 123 through the IP network 120. Furthermore, the media gateway controller 123 controls the media gateway 121, based on the No. 7 signals or control signals generated in response to the No. 7 signals.

In the above-described gateway system, when the subscriber terminal 102 originates a call requesting for an IP network service, an ISUP message, which is an MTP3 (message transfer part level-3) user message, is transmitted from the exchange 101 to the signalling gateway 122 through the SS7 network 110. The signalling gateway 122 transmits a control signal to a corresponding media gateway controller 123 according to information stored in this message. Then, the media gateway controller 123 controls a corresponding media gateway 121 according to the received control signal. Furthermore, necessary information is returned to the exchange 101 from the media gateway controller 123 through the signalling gateway 122 and SS7 network 110. As a result, a communication path that connects the existing line switching network and the IP network 120 is established.

Each node (the media gateway 121, signalling gateway 122, media gateway controller 123 and the like) installed in the IP network 120 is far smaller and inexpensive compared with the exchange 101 installed in the existing line switching network. By installing many such small nodes, a network configuration is made flexible. Therefore, it is anticipated that there will be a large number of nodes in the IP network.

In this case, if as shown in FIG. 2A, all nodes are connected to each other, the number of links to be managed by each node, such as an SCTP (Stream Control Transmission Protocol) link increases, and accordingly a lot of resources in each node are used.

In order to solve this problem, the configuration as shown in FIG. 2B, in which signalling transfer points (STP) are installed between nodes can be considered. Here, the STP is a node or device for transferring a signalling message. If this configuration is introduced into the IP network 120 shown in FIG. 1, each STP must be provided with a function to transfer an IP packet. Therefore, such an STP is often called “IP-STP”. A network system for attempting to increase the amount of traffic using such an STP is disclosed in Patent document 3.
The Patent document 1: Japanese Patent Laid-open Publication No. 2002-84363 (FIG. 1, paragraph 0022-0025)
The Patent document 2: Japanese Patent Laid-open Publication No. 2002-290551 (FIG. 1, paragraph 0031-0034)
The Patent document 3: Japanese Patent Laid-open Publication No. 2001-156922 (FIG. 1, abstract)

The IP network has realized a flexible system by connecting a lot of small and inexpensive communication devices unlike the existing line switching network. The configuration of the IP-STP is far smaller and much more inexpensive than that of an STP installed in the existing line switching network. Therefore, the process capability of the IP-STP is generally inferior to that of an STP installed in the existing line switching network. In other words, in the IP network, a lot of IP-STPs must be installed.

However, in the common channel signalling system, each node (including an IP-STP) is identified by a node identifier called “signalling point code (SPC)”. In this case, the number of bits of the SPC is fixedly determined. Therefore, as described above, when the number of IP-STPs increases, there are shortages of SPCs, which is a problem.

Since a different SPC is allocated to each of many IP-STPs, the work of setting information in order to manage IP-STPs in each signalling end point (SEP) becomes complex and troublesome.

### SUMMARY OF THE INVENTION

It is an object of the present invention to resolve the shortages of signalling point codes in the common channel signalling system. It is another object of the present invention to simplify the management of a network which uses the common channel signalling system.

The network system of the present invention includes a plurality of signalling end points and a plurality of signalling transfer points, and transfers a control signal of common channel signalling, based on a network identifier and a node identifier. The network system of the present invention comprises a setting unit setting a first network identifier to a logical network including the plurality of signalling end points and the plurality of signalling transfer points and also setting a second network identifier to a logical network including only the plurality of signal transfer points; and an allocation unit allocating node identifiers, that belong to the first group, to the plurality of signalling end points and the plurality of signalling transfer points in correspondence with the first network identifier and also allocating node identifiers, that belong to the second group, to the plurality of signalling transfer points in correspondence with the second network identifier. In this case, the number of node identifiers, that belong to the first group, allocated to the plurality of signalling transfer points is smaller than the number of the plurality of signalling transfer points.

In this network system, when a control signal is transferred between signalling transfer points, the first network identifier and a node identifier, that belong to the first group, allocated to a destination signalling endpoint is set in the control signal. When a control signal is transferred between signalling transfer points, the second network identifier and a node identifier, that belong to the second group, allocated to a destination signalling transfer point is set in the control signal. Thus, control signals can be transmitted/received between arbitrary signalling points.

### BRIEF DESCRIPTION OF THE DRAWINGS

FIG. 1 shows an example of the configuration of the conventional gateway system;

FIGS. 2A and 2B show connections between nodes;

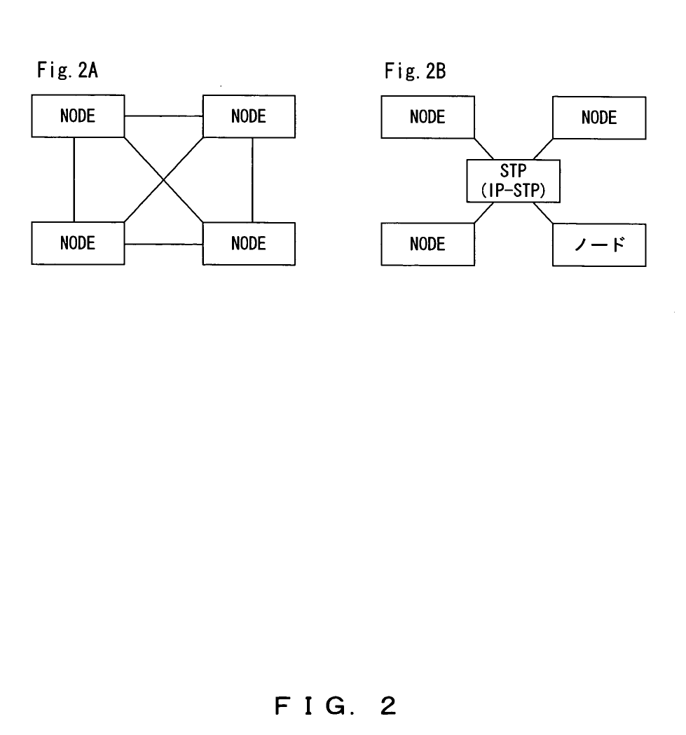

FIGS. 3A and 3B show the basic concept of the present invention;

FIG. 4 shows the configuration of the network system;

FIG. 5 shows the format of a control signal used in the common channel signalling system;

FIG. 6 shows an example of the allocation of a signalling point code;

FIG. 7 shows the configuration of the IP-STP;

FIGS. 8A through 8D show an example of a management table installed in each signalling point;

FIGS. 9A and 9B show an example of a routing table installed in each signalling point;

FIG. 10 shows the sequence of the first embodiment;

FIG. 11 shows the sequence of the second embodiment;

FIG. 12 shows the sequence of the third embodiment;

FIG. 13 shows the hardware configuration of the signalling end point and signalling transfer point; and

FIG. 14 shows the allocation of signalling point code in another embodiment.

### DESCRIPTION OF THE PREFERRED EMBODIMENTS

The network system of the present invention includes a plurality of signalling end points and a plurality of signalling transfer points to connect the plurality of signalling end points, and transfers a control signal of common channel signalling, based on a network identifier and a node identifier.

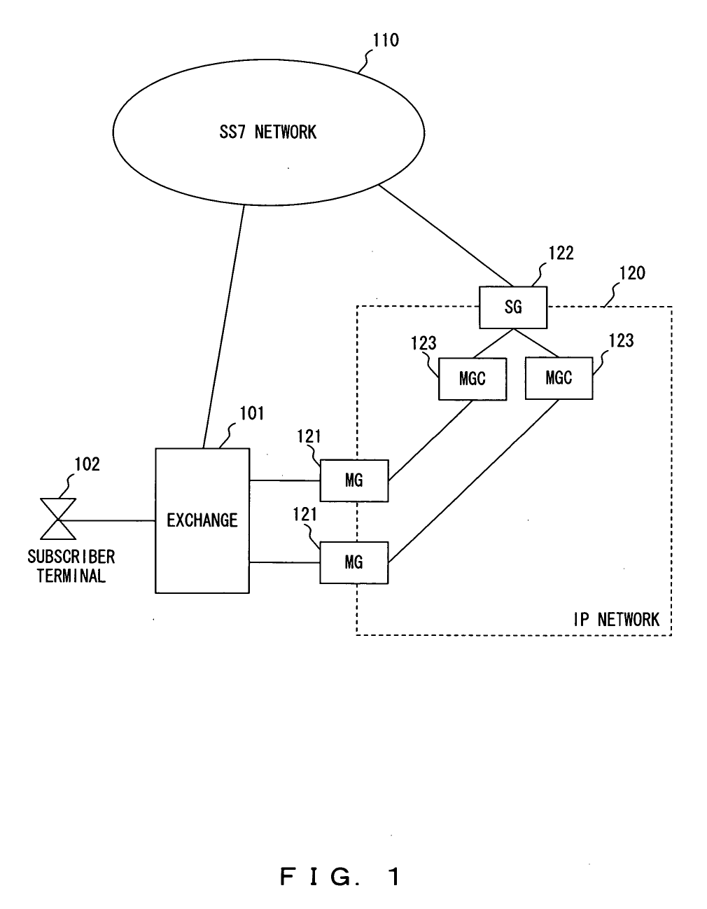

The signalling end point (hereinafter, sometimes referred to “SEP”) is a communication node with a function to process or handle a control signal of the common channel signalling. Although the SEP is not especially limited, for example, as shown in FIG. 1, the SEP comprises the media gateway (MG) 121, the signalling gateway (SG) 122 and the media gateway controller (MGC) 123. In the following description, the signalling end point SEP is often simply called “node”. On the other hand, the signalling transfer point (hereinafter, sometimes referred to “STP”) is a communication node with a function to transfer a control signal of the common channel signalling, and in the following embodiment, it is assumed to be an “IP-STP” installed in an IP network. Each of the signalling end points and signalling transfer points is identified by a node identifier called “SPC (Signalling Point Code)”. Although the common channel signalling system is not especially limited, for example, the No. 7 signalling system is used.

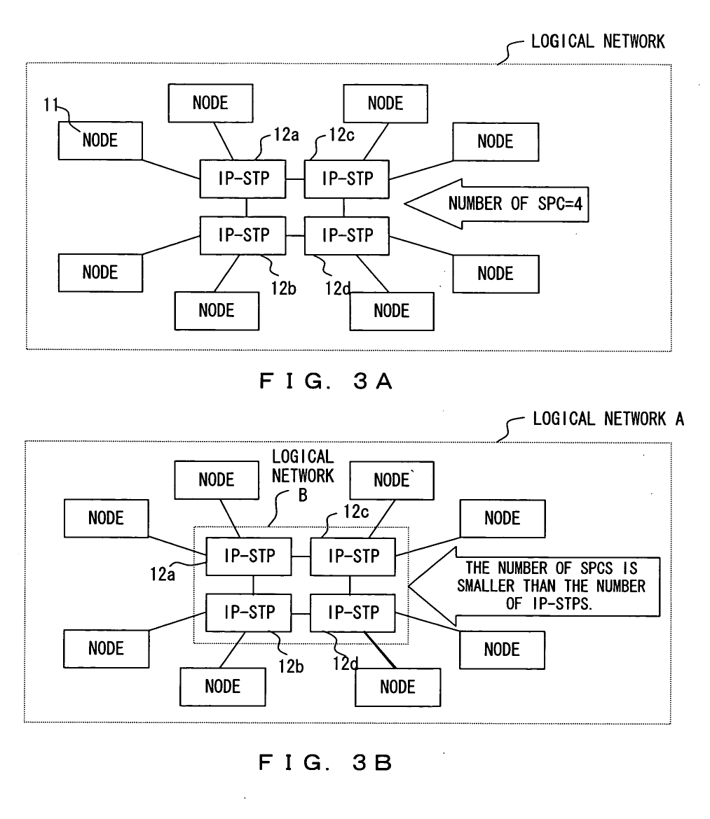

FIGS. 3A and 3B show the basic concept of the present invention. Here, as shown in FIG. 3A, it is assumed that in a network, a plurality of nodes 11 are connected to each other through four IP-STPs 12a-12d. Node 11 is the above-described signalling end point.

In this network, a different signalling point code is allocated to each of the plurality of nodes 11 and IP-STPs 12a-12d. Specifically, in the example of FIG. 3A, four signalling point codes in total are allocated to respective IP-STPS 12a-12d.

In the network system of the present invention, as shown in FIG. 3B, the number of signalling point codes allocated to IP-STPs is smaller than the number of IP-STPs. In other words, in the network system of the present invention, one signalling point code is allocated to a plurality of IP-STPs. For example, one signalling point code can be allocated to IP-STPs 12a-12d. In this case, node 11 recognizes that only one IP-STP exists. Alternatively, one signalling point code can be allocated to two of the IP-STPs 12a-12d, and another signalling point code can be allocated to the other two IP-STPs. In this case, node 11 recognizes that only IP-STPs exist.

A routing table used to transfer control signals in this network is divided and managed for each logical network. In the example of FIG. 3B, a logical network A is composed of a plurality of nodes 11 and IP-STPs 12a-12d. On the other hand, a logical network B is composed of IP-STPs 12a-12d. In a routing table provided for each IP-STP, information for signal transfer between nodes and signal transfer between a node and an IP-STP, and information for signal transfer between IP-STPs are separately managed.

As described above, in the network system of the present invention, since the number of signalling point codes to be allocated to IP-STPs is small, the shortage or exhaustion of a signalling point code is mitigated. In addition, since the number of signalling point codes to be allocated to IP-STPs is small, in each node 11, information about IP-STPs can be easily set and managed.

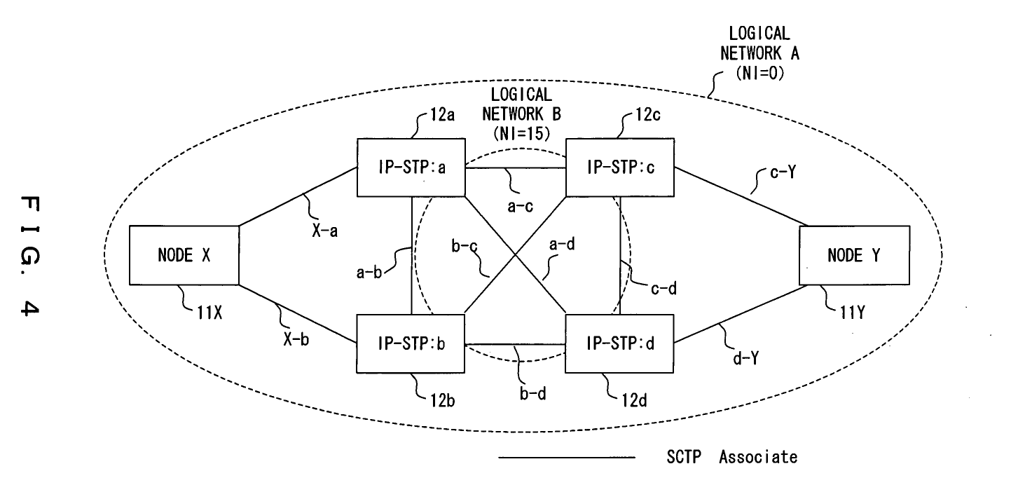

FIG. 4 shows the configuration of a network system for the following embodiments. In this case, the network system includes two signalling end points (nodes 11X and 11Y), four signalling transfer points (IP-STPs 12a through 12d) and ten links for connecting these signalling points (including SEPs and STPs). These links are called “associates” in an SCTP (Stream Control Transmission Protocol).

In this network system, a logical network A identified by “network identifier NI=0” and a logical network B identified by “network identifier NI=15” exist. In this case, in the logical network A, nodes 11X and 11Y and IP-STPs 12a-12d exist, and in the logical network B, IP-STPs 12a-12d exist.

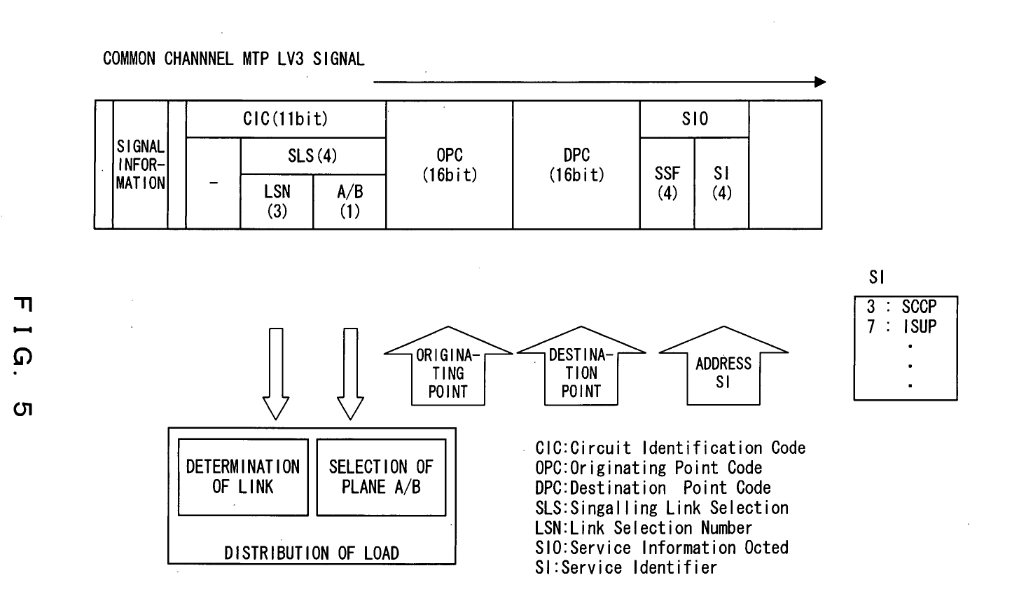

FIG. 5 shows the format of a control signal used in the common channel signalling system. FIG. 5 shows the format of an MTP3 (Mmessage Transfer Part level-3). The MTP is a protocol for transferring a message of the common channel signalling system.

“SIO” is composed of four bits of SI area and four bits of SSF area. “Network identifier NI” is set using two bits of this SSF bits. However, in the current domestic communication of Japan, “0” is fixedly used as the network identifier NI.

“DPC” is an area used to set the signalling point code of a destination signalling point, and “OPC” is an area used to set the signalling point code of an originating signalling point (that is, a source signalling point). In this example, 16 bits are allocated to each of “DPC” and “OPC”. “CIC” is a circuit identification code, and includes an “A/B bit”. The “A/B bit” designates which plane is used for a communication route, a plane A or a plane B, when a network is redundantly configured.

The above-described control signal is generated by an arbitrary signalling point. (including nodes 11X and 11Y and IP-STPs 12a-12d) shown in FIG. 4, and is transmitted to the network. Each signalling point refers to the “network identifier NI” and “destination signalling point code DPC” of the received signal, and transfers the signal to the destination signal point.

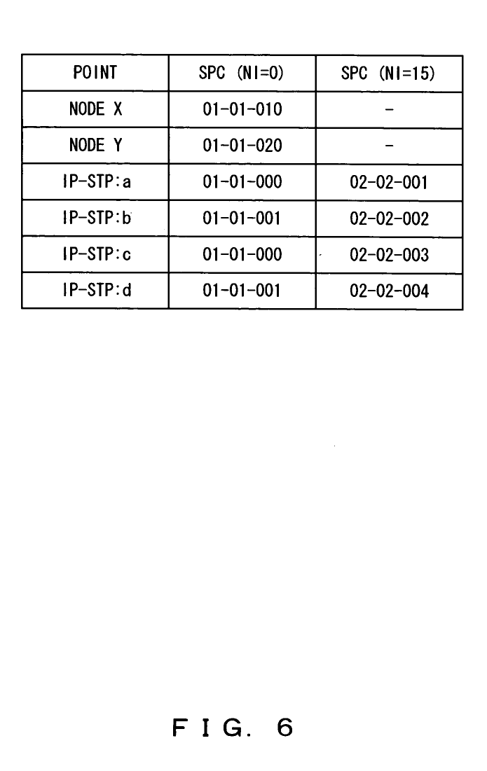

FIG. 6 shows the allocation of signalling point codes. The signalling point code is allocated, for example, by the manager of a network.

In the system of the embodiment, the signalling point code is allocated for each network identifier. Specifically, in the logical network A identified by “network identifier NI=0”, “NI=01-01-010” and “01-01-020” are allocated to nodes 11X and 11Y, respectively. In addition, “01-01-000” is allocated to each of the IP-STPs 12a and 12c, and “01-01-001” is allocated to each of the IP-STPs 12b and 12d.

As described above, in this logical network, different signalling point codes are allocated to corresponding signalling endpoints (nodes 11X and 11Y). However, a signalling point code whose number is smaller than the number of the signalling transfer points is allocated to each of the signalling transfer points (IP-STPs 12a-12d). More specifically, two signalling point codes are allocated to four signalling transfer points. Therefore, in this case, nodes 11X and 11Y can see only two signalling transfer points.

In differently view, a route via an IP-STP identified by “01-01-000” (node 11X, IP-STP 12a, IP-STP 12c and node 11Y) and a route via an IP-STP identified by “01-01-001” (node 11X, IP-STP 12b, IP-STP 12d and node 11Y) exist between nodes 11X and 11Y. In other words, a redundant configuration is realized. The former one and the latter one are often called “plane A” and “plane B”, respectively.

In the logical network B identified by “network identifier NI=15”, “02-02-001”, “02-02-002”, “02-02-003” and “02-02-004” are allocated to IP-STPs 12a, 12b, 12c and 12d, respectively. In other words, in this logical network, a different SPC is allocated to each signalling transfer point.

In the existing network where the above-described MTP3 signals are transferred, the network identifier NI is expressed using two bits in the SSF area shown in FIG. 5. However, in the system of the embodiment, the network identifier NI is expressed using four bits of the entire SSF area.

Each signalling point is provided with a local signalling point code table, an associate table and a routing table. The contents of these tables are set based on the above-described allocation of signalling point codes.

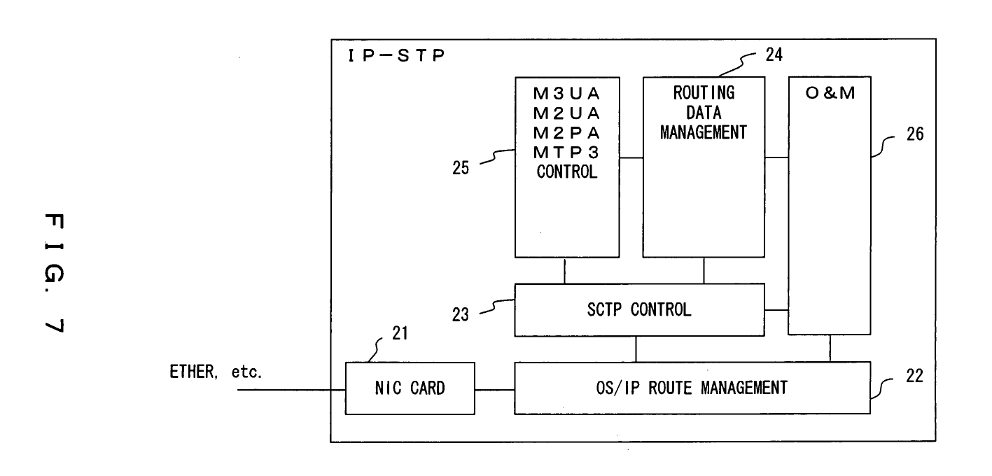

FIG. 7 shows the configuration of the IP-STP. A NIC card 21 provides an interface function to terminate a line. An OS/IP route management unit 22 performs the signal process of lower-order layers. An SCTP control unit 23 performs the signal process with respect to the SCTP (Stream Control Transmission Protocol). A routing data management unit 24 stores and manages information about the transfer of control signals (including a routing table). A transfer control unit 25 controls message transfer (MTP3 (Message Transfer Part level-3), M3UA (Mtp3-User Adaptation layer), M2UA, M2PA, Mtp3 and the like). An O/M unit 26 receives instructions from the manager of the system and sets information needed for the IP-STP.

The IP-STP is realized, for example, by installing the NIC card in a computer, and installing a program that describes the functions of the OS/IP route management unit 22 through O/M unit 26.

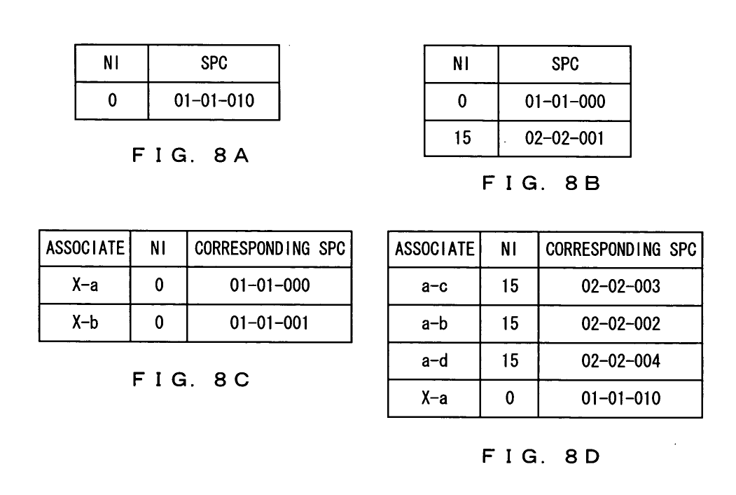

FIGS. 8A through 8D show examples of a management table provided for each signalling point. In these examples, assuming the system shown in FIG. 4, a management table provided for the node 11X and that provided for the IP-STP 12a are shown as an example of a management table provided for each signalling end point and that provided for each signalling transfer point, respectively.

FIGS. 8A and 8B are an example of a local signalling point code table provided for node 11X and that provided for IP-STP 12a, respectively. The local signalling point code table registers the combination of a network identifier NI for identifying a logical network to which the local signalling point belongs and an signalling point code SPC allocated to the local signalling point. Since each IP-STP (here IP-STP 12a) belongs to both of the logical networks A and B, as shown in FIG. 8B, both of the signalling point code in the logical network A and the one in the logical network B are registered.

FIGS. 8C and 8D are respective examples of an associate table provided for node 11X and IP-STP 12a respectively. In the associate table, the network identifier NI of a logical network to which each link belongs, and a signalling point code of a destination signalling point of the link (corresponding SPC) are registered for each link (that is an associate) connected to a local signalling point. For example, in FIG. 8C, “associate X-a”-indicates a link connecting the node 11x and the IP-STP 12a through a logical network identified by “NI=0”, and “associate X-a” indicates a link connecting the node 11X and the IP-STP 12b through a logical network identified by “NI=15”. In FIG. 8D, “associate a-c”, “associate a-b”, “associate a-d” and “associate X-a” indicate a link connecting IP-STP 12a and IP-STP 12c through a logical network identified by “NI=15”, one connecting IP-STP 12a and IP-STP 12b through a logical network identified by “NI=15”, one connecting IP-STP 12a and IP-STP 12d through a logical network identified “NI=15” and one connecting node 11X and IP-STP 12a through a logical network identified by “NI=0”, respectively.

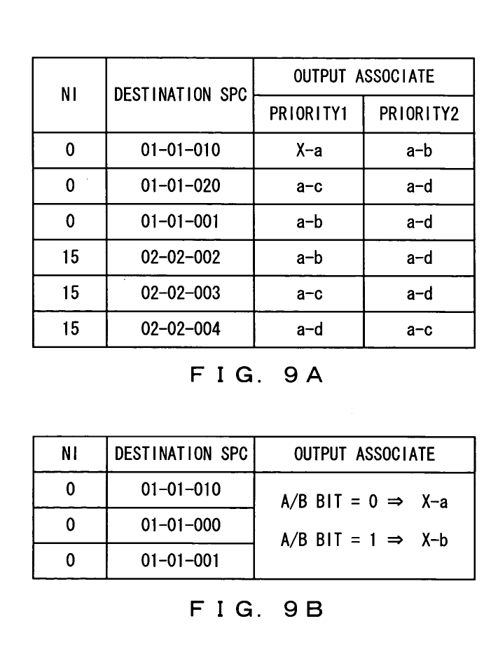

FIGS. 9A and 9B are examples of a routing table provided for each signalling point. In this example, assuming the system shown in FIG. 4, a routing table provided for the node 11X and that provided for the IP-STP 12a are shown in FIGS. 9A and 9B, as an example of a routing table provided for each signalling end point and an example of that provided for each signalling transfer point, respectively. These routing tables are used to transfer the control signal to the destination.

In FIG. 9A, on a first through third records, output associates for each destination signalling point in the logical network A identified by “network identifier NI=0” are registered. In this case, destinations registered in the third record is a signalling point identified by “SPC=01-01-001” in the logical network A, and are IP-STPs 12b and 12d. In fourth through sixth records, output associates for each destination signalling point in the local network B identified by “network identifier NI=15” are registered. If a plurality of output associates exists for one destination, priority is given to each output associate.

As shown in FIG. 9B, in each signalling end point, an output associate is determined by the value of the A/B bit shown in FIG. 5. In this example, information defining that associate X-a is selected when “A/B bit=0”, and associate X-b is selected when “A/B bit=1” is stored in the node 11X. A signalling end point that is going to transmit a control signal can designate the plane A or B of the redundantly configured IP-STP network, using the A/B bit. In other words, by properly setting the A/B bit in a signalling end point that is going to transmit a control signal, the load balance (load distribution) of the IP-STP network can be realized.

Next, examples of signal transfer in the above-described network system are described.

### The First Embodiment

In the first embodiment, the sequence in the case where a control signal is transferred from node 11X to node 11Y is described. In this example, the following information is set in a control signal generated by node 11X in the format shown in FIG. 5. That is to say, “NI=0” is set in the SSF area. In this case, “NI=0” can be set using the predetermined two bits specified in advance in the SSF area as in the conventional method. Alternatively, “NI=0” can be set using four bits of the entire SSF area. A signalling point code “01-01-020” indicating node 11Y and a signalling point code “01-01-010” indicating node 11X are set in the DPC area and the OPC area, respectively. Furthermore, it is assumed that “0” is set in “A/B bit”. A signal information area stores information, commands or the like to be notified to node 11Y.

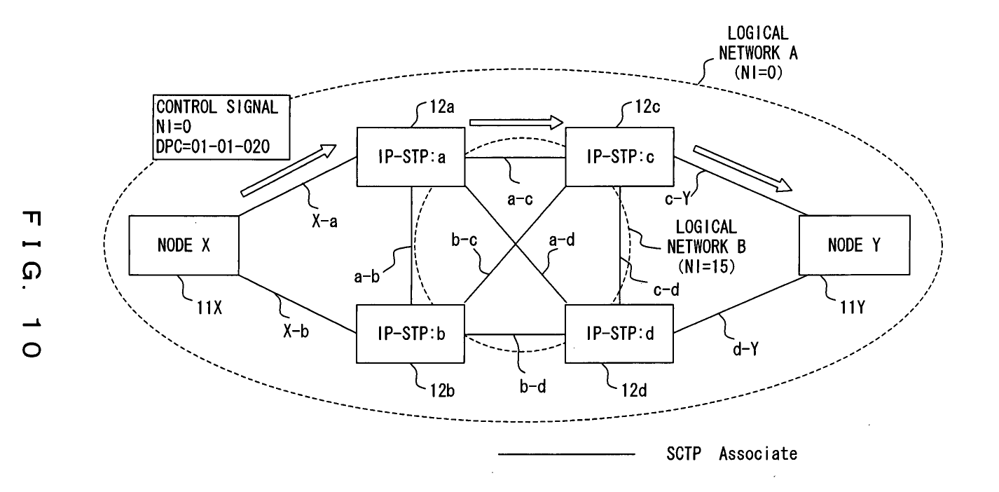

The control signal generated as described above is transferred from node 11X to node 11Y in the following sequence. This sequence is described below with reference to FIG. 10.
(1) The node 11X firstly selects the associate X-a according to “A/B bit=0” set in the control signal. Then, the control signal is transmitted through the selected associate X-a. As a result, this control signal is received by the IP-STP12a.
(2) The IP-STP 12a extracts a network identifier NI and a destination signalling point code DPC from the received control signal, and refers to the routing table using those values as retrieval keys. In this case, the routing table provided for IP-STP 12a is as shown in FIG. 9A. Therefore, “a-c” is obtained as an output associate, based on “NI=0” and “SPC=01-01-020”. Here, an output associate is selected according to the priority registered in the routing table. Then, the IP-STP 12a outputs the control signal received from the node 11X to associate a-c. As a result, this control signal is transferred to the IP-STP 12c.
(3) The operation of the IP-STP 12c is basically the same as that of the above-described IP-STP 12a. Specifically, the IP-STP 12c determines an output associate using the routing table, and outputs the control signal received from the IP-STP 12a to the determined associate. As a result, this control signal is transferred to the node 11Y.
(4) When the node 11Y detects that the destination signalling point code DPC of the received control signal coincides with a signalling point code of the node 11Y itself, the node 11Y performs an operation corresponding to a notice or command stored in the received control signal.

As described above, in the signal transfer between signalling end point, a control signal is transmitted to a desired signalling end point by setting “NI=0” as a network identifier and setting an signalling point code allocated on the logical network that is identified by that network identifier as a destination. In this case, each IP-STP transfers the control signal to the destination referring to information managed in correspondence with the network identifier in the routing table.

### The Second Embodiment

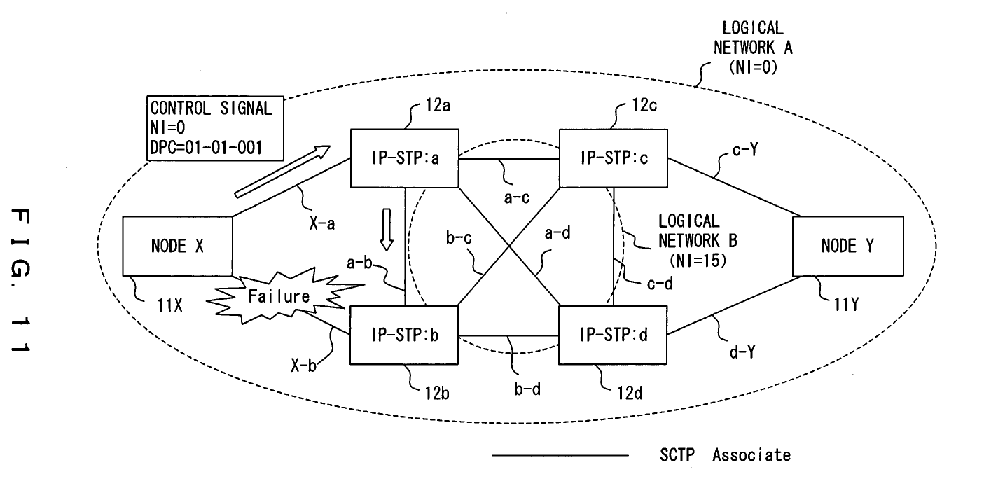

In the second embodiment, the sequence in the case where a failure occurs on the associate X-b that connects the node 11X and the IP-STP 12b is described. In this example, it is assumed that a failure occurs on the associate X-b while the control signal is transmitted from the node 11X to the IP-STP 12b. Specifically, it is assumed that before the failure has occurred, “NI=0” and “SPC=01-01-010” are set in the control signal, and the control signal is transmitted from the node 11X to the IP-STP 12b through the associate X-b. It is also assumed that the node 11X has detected the failure by some method (for example, a notice from the IP-STP 12b). The sequence of the second embodiment is described below with reference to FIG. 11.
(1) The node 11X sets the same network identifier NI and destination signalling point code DPC as that before the failure occurs in a subsequent control signal or a control signal to be re-transmitted. Specifically, “NI=0” and “DPC=01-01-010” are set in this control signal. However, since there is a failure on the associate X-b, “0” which indicates the plane A configured by the IP-STPs 12a and 12c is set in the A/B bit of this control signal.
(2) The node 11X transmits the control signal according to the A/B bit. Specifically, node 11X outputs the control signal to the associate X-a. As a result, the control signal is received by the IP-STP 12a.
(3) The IP-STP 12a extracts the network identifier NI and destination signalling point code DPC from the received control signal and refers to the routing table using these values as retrieval keys. In this case, the routing table provided for the IP-STP 12a is as shown in FIG. 9A. Therefore, “a-b” is obtained as an output associate, based on “NI=0” and “DPC=01-01-001”. Then, the IP-STP 12a outputs the received control signal to the associate a-b. As a result, this control signal is transferred to the IP-STP 12b.
(4) The IP-STP 12b performs an operation corresponding to a notice or a command stored in the received control signal.

As described above, even if a failure occurs in a link between a signalling end point and a signalling transfer point, the control signal is transferred to a target destination through another route by the same network identifier NI and destination signalling point code DPC as that before the failure occurs.

### The Third Embodiment

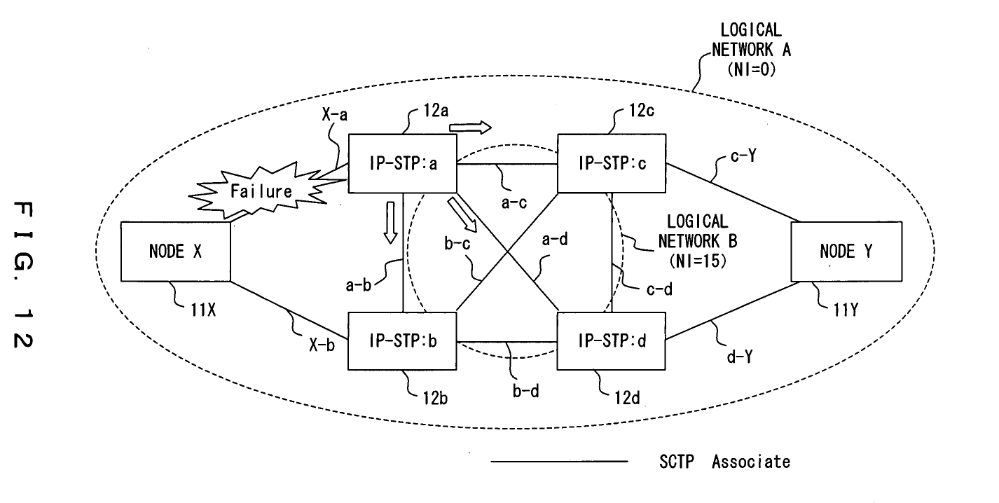

In the third embodiment, the sequence in the case where a failure occurs in the associate X-a that connects the node 11X and the IP-STP 12a is described below. More specifically, the sequence in the case where the IP-STP 12a detects the failure of the associate X-a and notifies all adjacent IP-STPs of the fact is described. The sequence of the third embodiment is described below with reference to FIG. 12.
(1) When the IP-STP 12a detects the failure, the IP-STP 12a refers to the associate table shown in FIG. 8D and recognizes all signalling points adjacent to the IP-STP 12a. Then, the IP-STP 12a generates control signals whose destinations are these recognized signalling points. However, since there is a failure in the associate X-a, a control signal whose destination is the node 11X is not generated. Specifically, control signals whose destinations are the IP-STPs 12b, 12c and 12d, respectively, are generated. In this case, these control signals are transmitted/received between signalling transfer points, “network identifier NI=15” is set in each of these control signals. As destination signalling point codes, values corresponding to “network identifier NI=15” (02-02-002, 02-02-003 and 02-02-004) are set. These control signals are transfer prohibition signals indicating that signal transfer through the associate X-a should be prohibited.
(2) The control signals generated thus are transmitted to each adjacent signalling point. In this case, a control signal with “NI=15, SPC=02-02-002”, a control signal with “NI=15, SPC=02-02-003” and a control signal with “NI=15, SPC=02-02-004” are transmitted to the IP-STP 12b through the associate a-b, to the IP-STP 12c through the associate a-c, and to the IP-STP 12d through the associate a-d, respectively.
(3) Each of the IP-SWTP 12b through 12d performs an operation corresponding to the received control signal (transfer prohibition signal). Specifically, for example, the routing table of each of the IP-STP is updated in such away that the associate X-a can be excluded from the transfer route of the control signal.

As described above, if a failure occurs in a link connected to an IP-STP, a transfer prohibition signal is transmitted from the IP-STP that has detected the failure to other IP-STPs. An IP-STP that has received the transfer prohibition signal updates the routing table in such a way as to set information for realizing a route that goes around a link in which the failure has occurred. Therefore, after that, the control signal goes around the link in which the failure has occurred and is transferred to a desired signalling point.

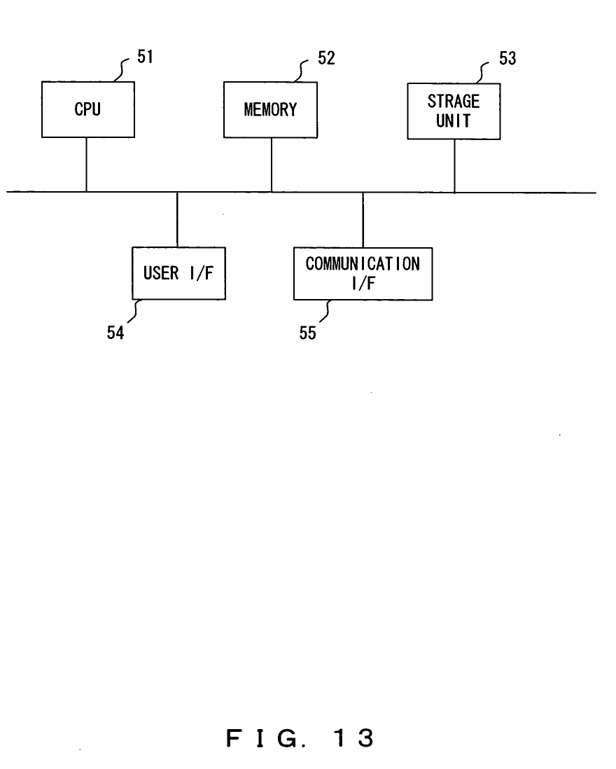

FIG. 13 shows the hardware configuration of a signalling end point and a signalling transfer point. The signalling end point and signalling transfer point of the embodiment can be realized, for example, by the computer shown in FIG. 13. The computer comprises a CPU 51, a memory 52, a storage unit 53, a user I/F unit 54 and a communication I/F unit 55. A program that describes the operation of the signalling end point or signalling transfer point is stored in the storage unit 53 (or the memory 52), and by executing the program, the above-described operations are realized. The tables shown in FIGS. 8A through 8D, 9A and 9B are stored in the memory 52 (or the storage unit 53).

The network identifier NI and signalling point code SPC are determined, for example, by a network manager and are set in a corresponding signalling point through the user I/F unit 54 or communication I/F unit 55. In this case, “the setting of network identifiers” and “the allocation of signalling point codes (node identifiers)” include the operation of registering determined values in a table provided for each signalling point.

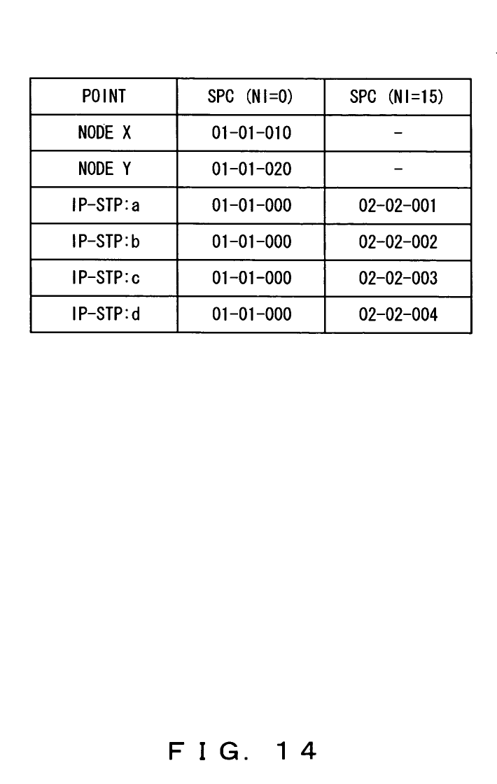

Although in the above-described embodiments, the IP-STP network is duplicated by allocating two signalling point codes to the IP-STP network, the present invention is not limited to this configuration. Specifically, as shown in FIG. 14, only one signalling point code may be allocated to the entire IP-STP network. In other words, an identical signalling point code may be allocated to all IP-STPs configuring the IP-STP network. Alternatively, more than three signalling point codes may be allocated to the IP-STP network. However, even in this case, the number of signalling point codes allocated to the entire IP-STP network must be smaller than the number of IP-STPs configuring the IP-STP network.

Although in the above-described embodiments, the “No. 7” is adopted as one form of the common channel signalling system, the present invention is not limited to this, and the present invention is applicable to a network system that transfers a signal of another common channel signalling system.

Furthermore, although in the above-described embodiments, a system for providing an IP network service through the existing line switching network is assumed, the present invention is not limited to this. Specifically, the signalling end point of the present invention is not limited to a media gateway, a signalling gateway and a media gateway controller. The signalling transfer point of the present invention is not limited to an IP-STP provided for an IP network.

According to the present invention, since the number of signalling point codes to be allocated to signalling transfer points is small, the shortage of the signalling point codes in a common channel signalling system can be resolved or mitigated. Accordingly, the management of a network using a common channel signalling system can be simplified.

1. A network system including a plurality of signalling end points and a plurality of signalling transfer points that transfers a control signal of common channel signalling based on a network identifier and a node identifier, comprising:
a setting unit which sets a first network identifier to a logical network including a plurality of signalling end points and a plurality of signalling transfer points, and sets a second network identifier to a logical network including only the plurality of signalling transfer points; and
an allocation unit which allocates a node identifier, that belongs to the first group, to the plurality of signalling end points and the plurality of signalling transfer points in correspondence with the first network identifier, and allocates a node identifier, that belongs to the second group, to the plurality of signalling transfer points in correspondence with the second network identifier, wherein
the number of node identifiers, that belong to the first group, allocated to the plurality of signalling transfer points is smaller than the number of the plurality of signalling transfer points.

2. The network system according to claim 1, wherein
the first network identifier is used for signal transfer between the signalling end points and the second network identifier is used for signal transfer between the signalling transfer points.

3. The network system according to claim 2, wherein
the first network identifier is also used for signal transfer between the signalling end point and the signalling transfer point.

4. The network system according to claim 1, wherein
the first network identifier and anode identifier that belongs to the first group are used for signal transfer between the signalling end points, and the second network identifier and a node identifier that belongs to the second group are used for signal transfer between the signalling transfer points.

5. The network system according to claim 1, wherein
said allocation unit allocates an identical node identifier that belongs to the first group to the plurality of signalling transfer points.

6. The network system according to claim 1, wherein
said allocation unit allocates a first node identifier that belongs to the first group to a part of signalling transfer points of the plurality of signalling transfer points, and allocates a second node identifier that belongs to the first group to the remaining signalling transfer points of the plurality of signalling transfer points.

7. The network system according to claim 1, wherein
the said allocation unit overlappingly allocates a node identifier that belongs to the first group to the plurality of signalling transfer points.

8. The network system according to claim 1, wherein
each of the plurality of signalling end points comprises a link information storage unit which stores a combination of the first network identifier and a node identifier that belongs to the first group as information for identifying a link to an adjacent signalling transfer point.

9. The network system according to claim 1, wherein
each of the plurality of signalling transfer points comprises a link information storage unit which stores a combination of the first network identifier and a node identifier that belongs to the first group as information for identifying a link to an adjacent signalling end point and a combination of the second network identifier and a node identifier that belongs to the second group as information for identifying a link to an adjacent signalling transfer point.

10. The network system according to claim 1, wherein
each of the plurality of signalling transfer points comprises a routing table which registers link information indicating a link to which the control signal is to be outputted for each destination information designated by a node identifier that belongs to the first group or a node identifier that belongs to the second group.

11. The network system according to claim 10, wherein
the link information includes information indicating priority in a plurality of links to output the control signal.

12. The network system according to claim 10, wherein
each of the plurality of signalling transfer points comprises:
a notification unit which notifies other signalling transfer points of failure information indicating a link in which a failure has occurred; and
an update unit which updates the routing table according to the notified failure information.

13. A network system including a plurality of signalling end points and a plurality of signalling transfer points that transfers a control signal of common channel signalling based on a network identifier and a node identifier, comprising:
a setting unit which sets a first network identifier for signal transfer between the signalling end points and a second network identifier for signal transfer between the signalling transfer point; and
an allocation unit which allocates a node identifier, that belongs to the first group, to the plurality of signalling end points and the plurality of signalling transfer points in correspondence with the first network identifier, and allocates a node identifier, that belongs to the second group, to the plurality of signalling transfer points in correspondence with the second network identifier, wherein
the number of node identifiers, that belong to the first group, allocated to the plurality of signalling transfer points is smaller than the number of the plurality of signalling transfer points.

14. A method for configuring a network system including a plurality of signalling end points and a plurality of signalling transfer points that transfers a control signal of common channel signalling based on a network identifier and a node identifier, comprising:
setting a first network identifier to a logical network including a plurality of signalling end points and a plurality of signalling transfer points;
setting a second network identifier to a logical network including only the plurality of signalling transfer points;
allocating a node identifier, that belongs to the first group, to the plurality of signalling end points and the plurality of signalling transfer points in correspondence with the first network identifier; and
allocating a node identifier, that belongs to the second group, to the plurality of signalling transfer points in correspondence with the second network identifier, wherein
the number of node identifiers, that belong to the first group, allocated to the plurality of signalling transfer points is smaller than the number of the plurality of signalling transfer points.
